(19) United States
(12) Patent Application Publication
(10) Pub. No.: US 2016/0267396 A1
(43) Pub. Date: Sep. 15, 2016

(54) System and Method for Using Machine Learning to Generate a Model from Audited Data

(71) Applicant: Skytree, Inc., San Jose, CA (US)

(72) Inventors: Alexander Gray, Santa Clara, CA (US); Sergey Kirshner, Palo Alto, CA (US)

(21) Appl. No.: 15/065,534

(22) Filed: Mar. 9, 2016

Related U.S. Application Data
(60) Provisional application No. 62/130,501, filed on Mar. 9, 2015.

(51) Int. Cl. G06N 99/00

(52) U.S. Cl. CPC G06N 99/005

(57) ABSTRACT

A system and method for using machine learning to generate a model from audited data includes a plurality of data sources, a training server having a machine learning unit, and a prediction/scoring server having a machine learning model and a data repository. The training server is coupled to receive and process information from the plurality of the resources and store it in the data repository. The training server, in particular, the machine learning unit fuses the input data and ground truth data. The machine learning unit applies machine learning to the fused input data and ground truth data to create a model. The machine learning unit then provides the model to the prediction/scoring server for use in processing new data. The prediction/scoring server uses the model to process new data and provide or take actions prescribed by the model.

### CROSS REFERENCE TO RELATED APPLICATIONS

The present application claims priority, under 35 U.S.C. §119, of U.S. Provisional Patent Application No. 62/130,501, filed Mar. 9, 2015 and entitled “System and Method for Using Machine Learning to Generate a Model from Audited Data,” which is incorporated by reference in its entirety.

### BACKGROUND

The present disclosure relates to machine learning systems. More particularly, the present disclosure relates to systems and methods for using machine learning to generate a model from audited data. Still more particularly, the present disclosure relates to applying the model generated from audited data to process new data for prediction and analysis.

One problem for complex processing systems is ensuring that they are operating within desired parameters. One prior art method for ensuring that complex processing systems are operating within desired parameters is to conduct a manual audit of the information used to make a decision and the decision made on that information. The problem with such an approach is that typically the audit is performed at a time well after the decision is made. Another problem is making use of this data retrieved from performing the audit to effectively improve how the complex processing system operates on new data. These are just some of the problems in using audit information to improve the operation of the complex processing systems.

### SUMMARY

The present disclosure overcomes the deficiencies of the prior art by providing a system and method for generating a model from audited data and systems and methods for using the model generated from the audited data to process new data. In one embodiment, the system of the present disclosure includes: a plurality of data sources, a training server having a machine learning unit, a prediction/scoring server having a machine learning predictor, and a data repository. The training server is coupled to receive and process information from the plurality of the resources. The training server processes the information received from the plurality of the resources and stores it in the data repository. The training server, in particular, the machine learning unit fuses the input data and ground truth data. The machine learning unit applies machine learning to the fused input data and ground truth data to create a model. The machine learning unit then provides the model to the prediction/scoring server for use in processing new data. The prediction/scoring server uses the model to process new data and provide or take actions prescribed by the model.

In general, another innovative aspect of the present disclosure described in this disclosure may be embodied in a method for generating a model from audited data comprising: receiving input data; receiving ground truth data; fusing the input data and the ground truth data to create fused data; applying machine learning to create a model from the fused data.

Other aspects include corresponding methods, systems, apparatus, and computer program products for these and other innovative aspects. These and other embodiments may each optionally include one or more of the following features.

For instance, the operations further include receiving unprocessed data, processing the unprocessed data with the model created from the fused data to identify an action, and one or more of providing the action and performing the action. For instance, the operations further include identifying a common identifier, fusing the input data and the ground truth data using the common identifier, and performing data preparation on the fused data. For instance, the features further include the input data relating to a complex processing workflow. For instance, the features further include the ground truth data being received from an auditor. For instance, the features further include the model including one or more of a classification model, a regression model, a ranking model, a semi-supervised model, a density estimation model, a clustering model, a dimensionality reduction model, a multidimensional querying model and an ensemble model. For instance, the features further include the action including one or more of a preventive action, generating a notification, generating qualitative insights, identifying a process from the input data for additional review, requesting more data, delaying the action, determining causation, and updating the model. For instance, the features include the ground truth data including one or more of validity data, qualification data, quantification data, correction data, preference data, likelihood data or similarity data.

The present disclosure is particularly advantageous because the model learned from the audited data may processes the new incoming data to identify whether there is a deviation from an expected norm and prescribes an interventional action that may prevent the deviation from happening. The model learned from the audited data may also process unaudited data to detect possible deviations from the norm and obtain an insight into the mechanisms responsible for the deviation.

The features and advantages described herein are not all-inclusive and many additional features and advantages should be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1A is a block diagram illustrating an example of a system for generating a model using audited data and using the model to process new data in accordance with one embodiment of the present disclosure.

FIG. 1B is a block diagram illustrating another example of a system for generating a model using audited data and using the model to process new data in accordance with another embodiment of the present disclosure.

FIG. 2 is a block diagram illustrating an example of a training server in accordance with one embodiment of the present disclosure.

FIG. 3 is a block diagram illustrating an example of machine learning models in accordance with one embodiment of the present disclosure.

FIG. 4 is a block diagram illustrating an example of a prediction/scoring server in accordance with one embodiment of the present disclosure.

FIG. 5 is a flowchart of an example method for generating a model using audited data and using the model to process new data in accordance with one embodiment of the present disclosure.

FIG. 6A is a flowchart of a first example of a method for receiving input data in accordance with one embodiment of the present disclosure.

FIG. 6B is a flowchart of a second example of a method for receiving input data in accordance with another embodiment of the present disclosure.

FIG. 6C is a flowchart of a third example of a method for receiving input data in accordance with yet another embodiment of the present disclosure.

FIG. 7 is a flowchart of an example of a method for receiving labels or ground truth data in accordance with one embodiment of the present disclosure.

FIG. 8 is a flowchart of an example of a method for identifying an action in response to processing new data with the model created from audited data in accordance with one embodiment the present disclosure.

### DETAILED DESCRIPTION OF PREFERRED EMBODIMENTS

A system and method for generating a model from audited data and systems and methods for using the model generated from audited data to process new data are described. In the following description, for purposes of explanation, numerous specific details are set forth in order to provide a thorough understanding of the disclosure. It should be apparent, however, that the disclosure may be practiced without these specific details. In other instances, structures and devices are shown in block diagram form in order to avoid obscuring the disclosure. For example, the present disclosure is described in one embodiment below with reference to particular hardware and software embodiments. However, the present disclosure applies to other types of embodiments distributed in the cloud, over multiple machines, using multiple processors or cores, using virtual machines or integrated as a single machine.

Reference in the specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment. In particular the present disclosure is described below in the context of multiple distinct architectures and some of the components are operable in multiple architectures while others are not.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers or memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Aspects of the method and system described herein, such as the logic, may also be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, and so on.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems should appear from the description below. In addition, the present disclosure is described without reference to any particular programming language. It should be appreciated that a variety of programming languages may be used to implement the teachings of the disclosure as described herein.

### Example System(s)

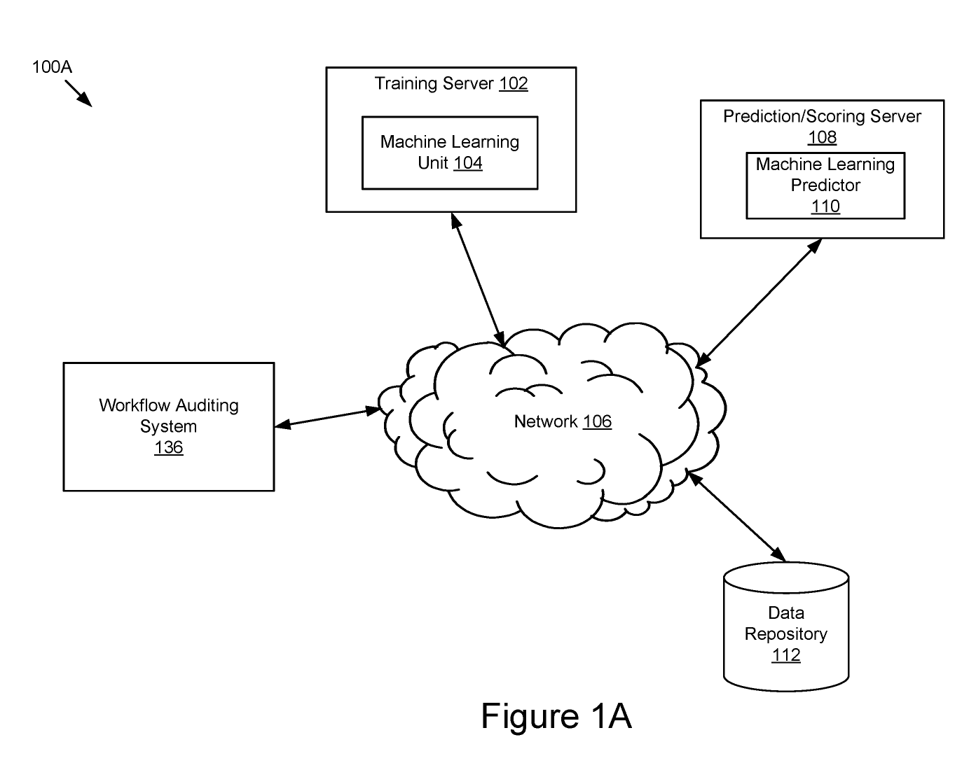

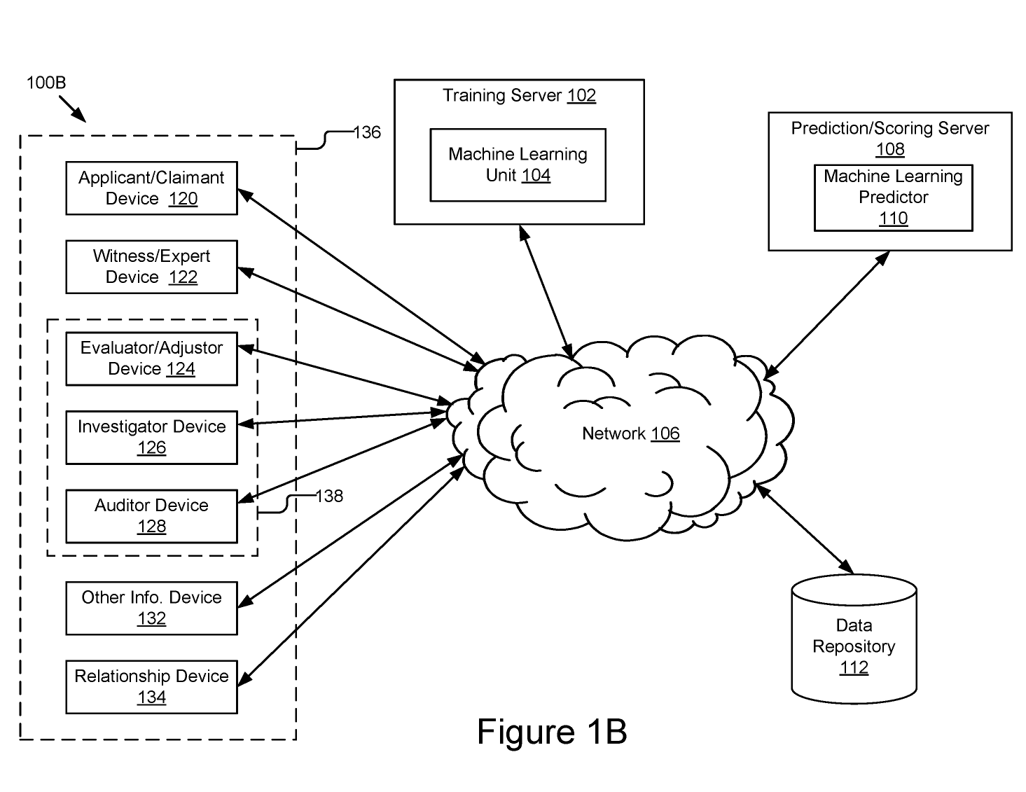

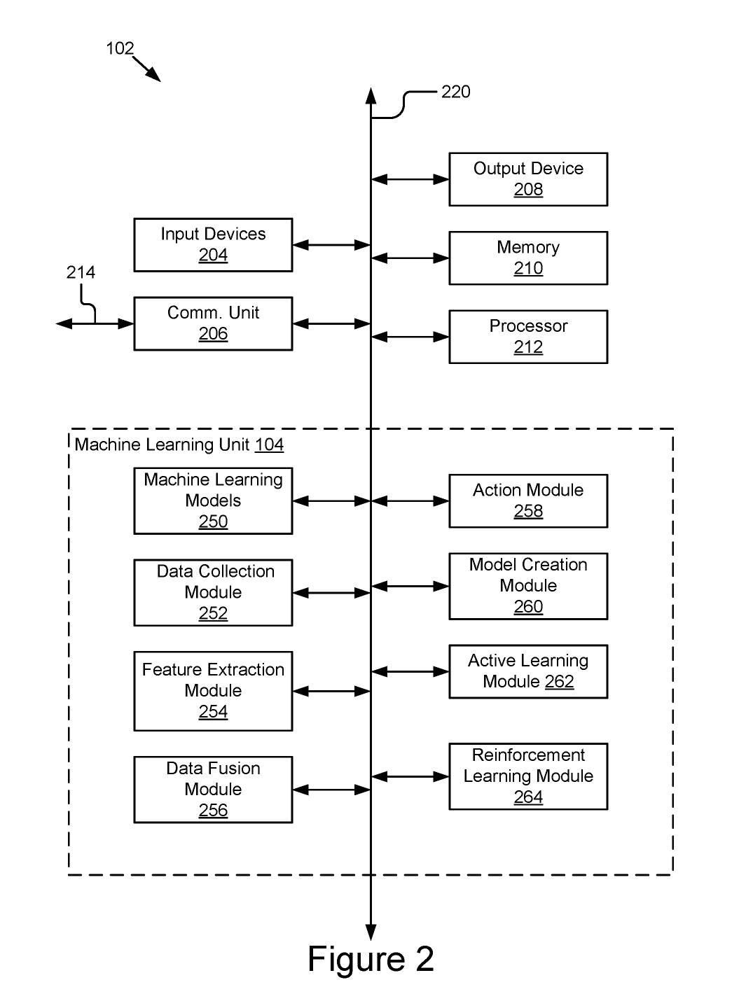

FIG. 1A is a block diagram illustrating an example of a system for generating a model using audited data and using the model to process new data in accordance with one embodiment of the present disclosure. Referring to FIG. 1A, the illustrated system 100A comprises: a workflow auditing system 136, a training server 102 including a machine learning unit 104, a prediction/scoring server 108 including a machine learning predictor 110 and a data repository 112. The training server 102 is coupled to receive and process information from the workflow auditing system 136. The training server 102 processes the information received from the workflow auditing system 136 and stores it in the data repository 112. The training server 102, in particular, the machine learning unit 104 (discussed in detail below with reference to FIG. 2) fuses the input data and ground truth data received from the workflow auditing system 136. The machine learning unit 104 applies machine learning to the fused input data and ground truth data to create a model. The machine learning unit 104 then provides the model to the prediction/scoring server 108 for use in processing new data. The prediction/scoring server 108 uses the model to process new data received by a complex processing workflow and provide or take actions prescribed by the model. In the depicted embodiment, these entities of the system 100A are communicatively coupled via a network 106.

The network 106 is a conventional type, wired or wireless, and may have any number of different configurations such as a star configuration, token ring configuration or other configurations known to those skilled in the art. Furthermore, the network 106 may comprise a local area network (LAN), a wide area network (WAN) (e.g., the Internet), and/or any other interconnected data path across which multiple devices may communicate. In yet another embodiment, the network 106 may be a peer-to-peer network. The network 106 may also be coupled to or include portions of a telecommunications network for sending data in a variety of different communication protocols. In some instances, the network 106 includes Bluetooth communication networks or a cellular communications network for sending and receiving data including via short messaging service (SMS), multimedia messaging service (MMS), hypertext transfer protocol (HTTP), direct data connection, wireless application protocol (WAP), email, etc.

The training server 102 is coupled to the network 106 for communication with other components of the system 100A, such as the workflow auditing system 136, the prediction/scoring server 108, and the data repository 112. In some embodiments, the training server 102 may be either a hardware server, a software server, or a combination of software and hardware. In the example of FIG. 1A, the training server 102 includes a machine learning unit 104 as described in more detail below with reference to FIG. 2. The training server 102 processes the information received from the workflow auditing system 136, fuses the input data and ground truth data, and applies machine learning to the fused input data and ground truth data to create a model.

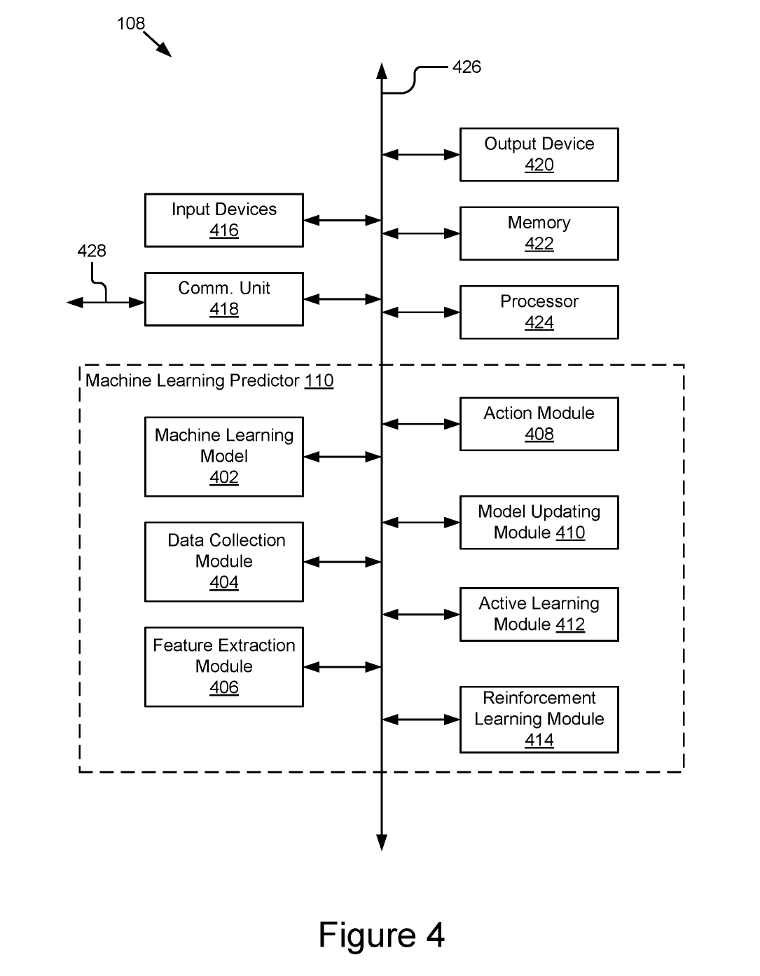

The prediction/scoring server 108 is coupled to the network 106 for communication with other components of the system 100A, such as the workflow auditing system 136, the training server 102, and the data repository 112. In some embodiments, the prediction/scoring server 108 may be either a hardware server, a software server, or a combination of software and hardware. In the example of FIG. 1A, the prediction/scoring server 108 includes a machine learning predictor 110 as described below with reference to FIG. 4. The prediction/scoring server 108 receives a model from the training server 102, uses the model to process new data and provides or takes one or more actions prescribed by the model.

Although only a single training server 102 is shown in FIG. 1A, it should be understood that there may be a number of training servers 102 or a server cluster, which may be load balanced. Similarly, although only a single prediction/scoring server 108 is shown in FIG. 1A, it should be understood that there may be a number of prediction/scoring server 108 or a server cluster, which may be load balanced.

The data repository 112 is coupled to the training server 102 and the prediction/scoring server 108 via the network 106. The data repository 112 is a non-volatile memory device or similar permanent storage device and media. The data repository 112 stores data and instructions and comprises one or more devices such as a storage array, a hard disk drive, a floppy disk drive, a CD-ROM device, a DVD-ROM device, a DVD-RAM device, a DVD-RW device, a flash memory device, or some other mass storage device known in the art. The data repository 112 stores information collected from the workflow auditing system 136. In one embodiment, the data repository 112 may also include a database for storing data, results, transaction histories and other information for the training server 102 and the prediction/scoring server 108.

The workflow auditing system 136 includes one or more data sources associated with a complex processing workflow that allow input of different types of data or information (automated and non-automated) related to a complex processing task to be provided or input to the training server 102 and/or the prediction/scoring server 108. It should be recognized that the workflow auditing system 136 and components thereof may vary based on the complex processing task that is audited. For clarity and convenience, the disclosure herein occasionally makes reference to examples where the complex processing workflow is insurance claim processing or credit card fraud identification. It should be noted that these are merely examples of complex processing workflows and other complex processing workflows exist and are within the scope of this disclosure. For example, it should be recognized that the disclosure herein may be adapted to complex processing workflows including, but not limited to, enforcement of licenses, royalties, and contracts in general, safety inspections, civil litigations, criminal investigations, college admissions, fraud detection, customer churn, new customer acquisition, preventive maintenance, and tax audits (both by the tax collection agencies for determination of a probability of a return being fraudulent or ranking of the returns according to how much they are underestimating the expected tax owed, and by the entities filing tax statements for estimation of the likelihood of being audited and the potential results of such audit).

In the example context of insurance claims and claim leakage, insurance claims are processed based upon a large amount of data. For example, the information used to determine the correct amount to pay on an insurance claim may include claimant information, profile data, expert witness data, witness data, medical data, investigator data, claims adjuster data, etc. This information is collected and processed and then the claim is paid. Sometime thereafter, an audit may be conducted of a small sampling of all the claims that were paid. As mentioned above, the workflow auditing system 136 and components thereof may vary based on the complex processing task that is audited. In the context of insurance claims and claim leakage, the workflow auditing system 136 may include a plurality of sources (e.g. a plurality of devices) for receiving or generating the above identified information used to determine the correct amount to pay on an insurance and the results of the audit conducted.

The plurality of data sources may also include an auditor device that provides an audit of a sample of information and a decision made on the sampled information in the complex processing workflow. The training server 102 processes the information received from the plurality of data sources associated with the workflow auditing system 136, fuses the input data and ground truth data, and applies machine learning to the fused input data and ground truth data to create a model. An example of the workflow auditing system 136 in the example context of insurance claims process based upon a large amount of data is described in more detail with reference to FIG. 1B.

FIG. 1B illustrates an example of a system 100B for generating a model using audited data and using the model to process new data in the example context of insurance claims processing workflow. Referring now to FIG. 1B, the illustrated system 100B includes a detailed view of one embodiment of a workflow auditing system 136 for an insurance claim processing workflow. It should be noted that the workflow auditing system 136 is shown here as a dashed line to indicate that the plurality of data sources (i.e. devices 120-134) are components of the workflow auditing system 136, in the example context of insurance claims processing workflow. Data sources, such as devices 120-134 may receive input of different types of data or information related to that complex processing workflow.

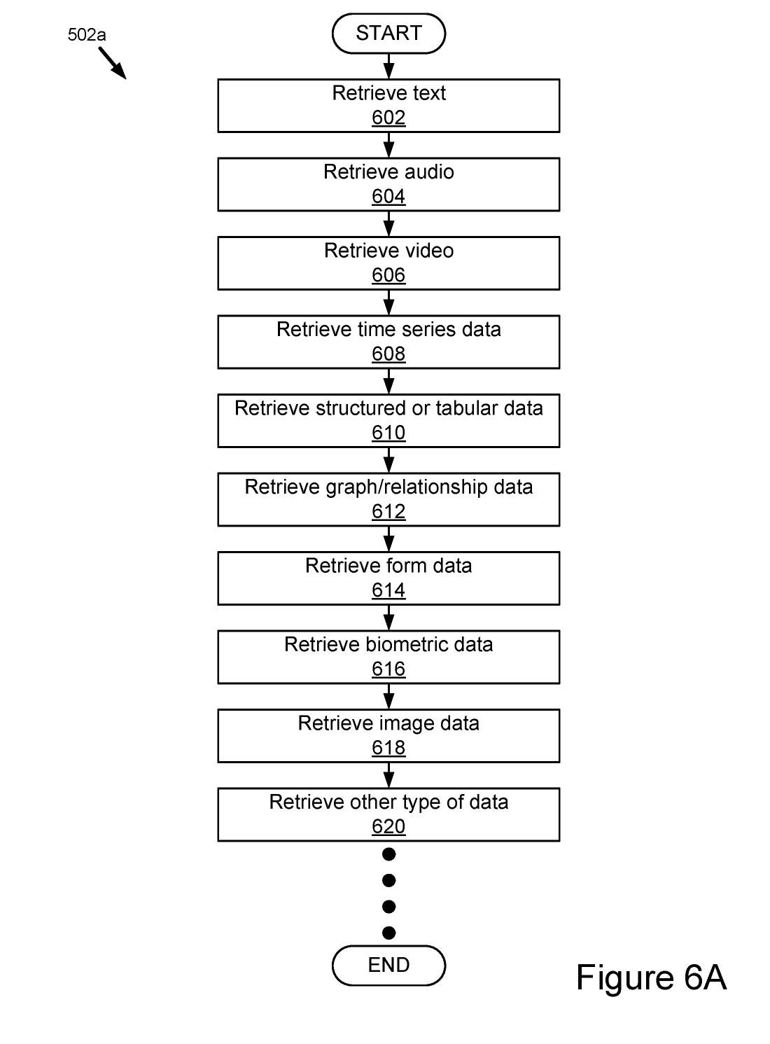

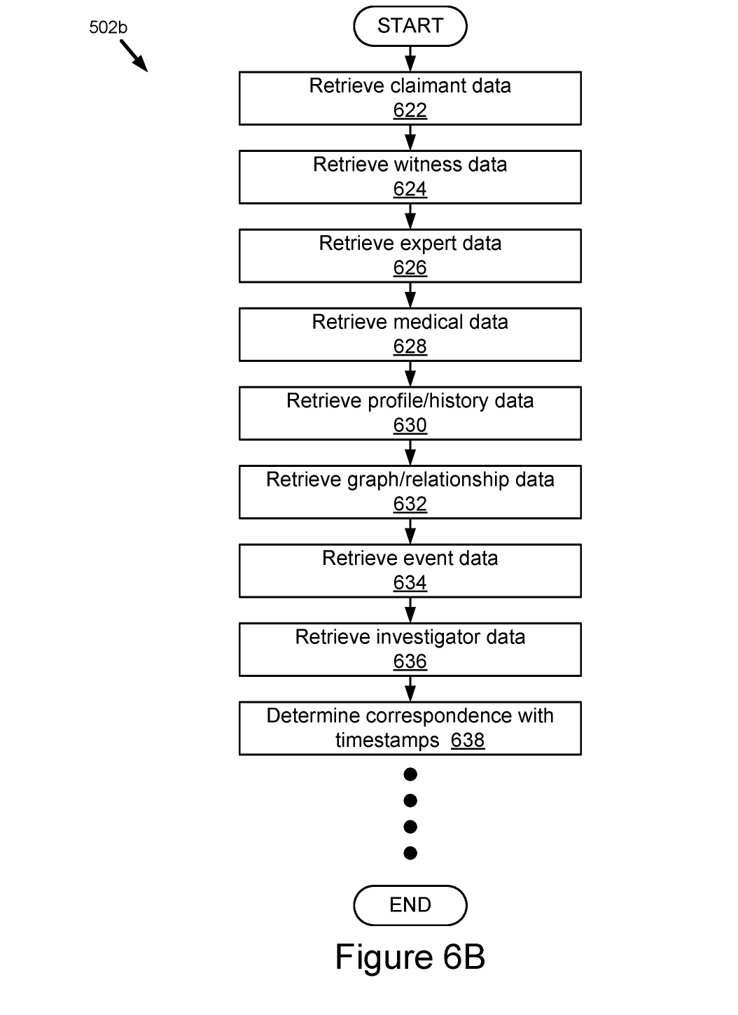

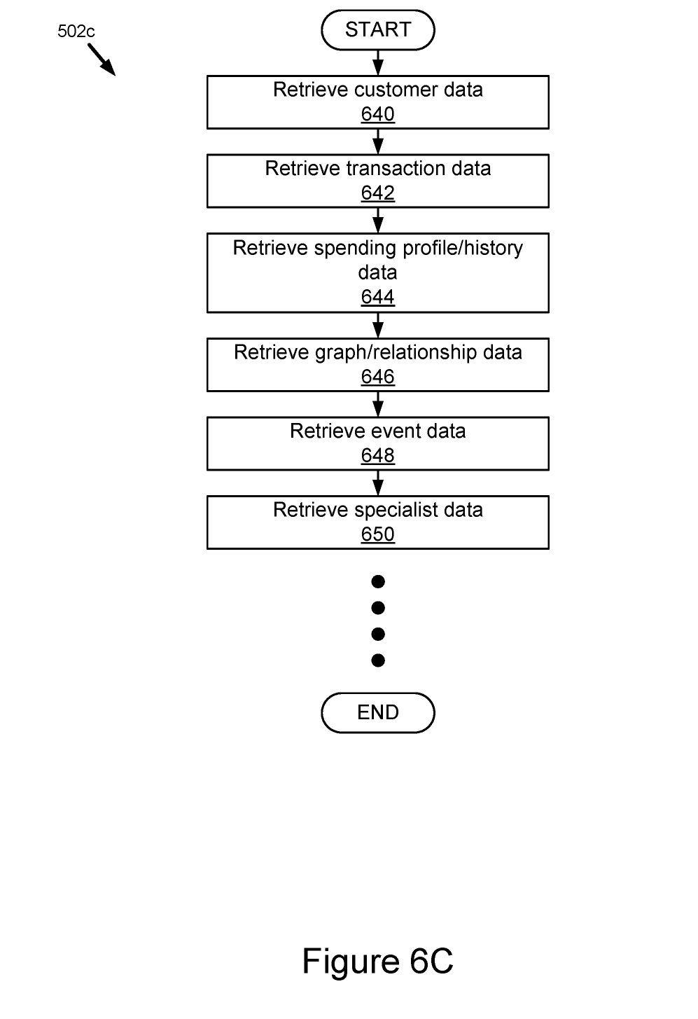

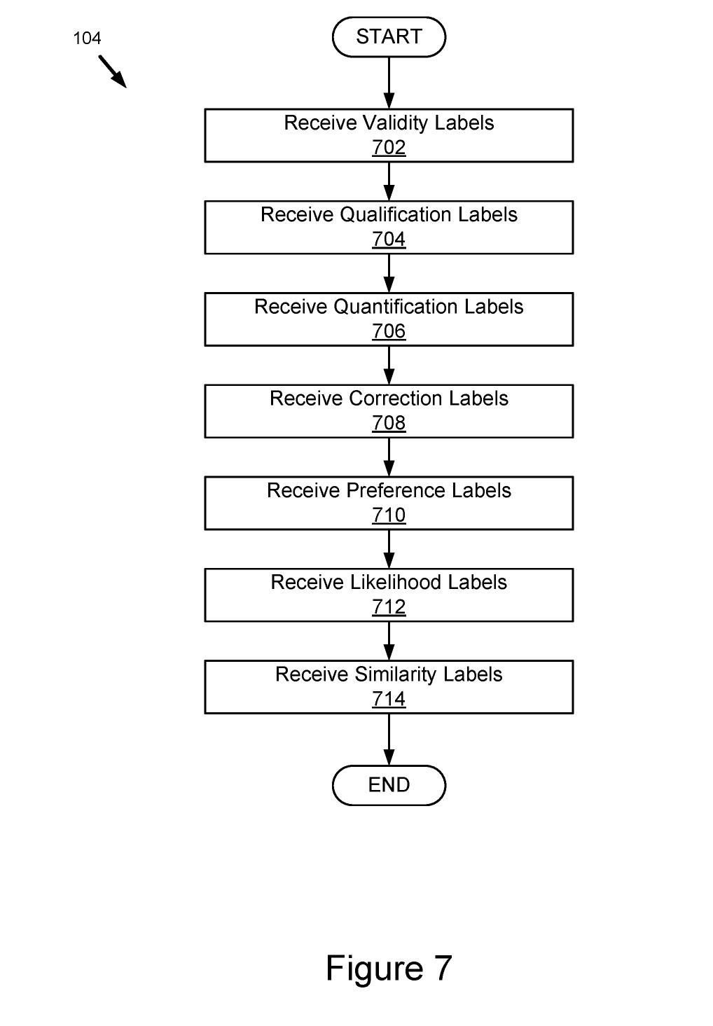

In some embodiments, one or more of the data sources 120-134 may be a device of a type that may include a memory and a processor, for example a server, a personal computer, a laptop computer, a desktop computer, a tablet computer, a mobile telephone, a personal digital assistant (PDA), a mobile email device, a portable game player, a portable music player, a television with one or more processors embedded therein or coupled thereto or other electronic device capable of accessing the network 106. In some embodiments, one or more of the data sources 120-134 may be a sensor, for example, an image sensor, a pressure sensor, a humidity sensor, a gas sensor, an accelerometer, etc. capable of accessing the network 106 to provide a corresponding output. In some embodiments, one or more of the data sources 120-134 may include a browser for accessing online services. In the illustrated embodiment, one or more users may interact with the data sources 120-134. The data sources 120-134 are communicatively coupled to the network 106. The one or more users interacting with the data sources 120-134 may provide information in various formats as input data described below with reference to FIGS. 6A-6C or, when the user is an auditor, as ground truth data described below with reference to FIG. 7.

Each of the data sources 120-134 included within the workflow auditing system 136 is capable of delivering information as described herein. While the system 100B shows only one device 120-134 of each type, it should be understood that the system 100B may include any number of devices 120-134 of each type to collect and provide information for storage in the data repository 112.

As indicated above, the workflow auditing system 136 and the components thereof may vary based on the complex process workflow. Similarly, the information those components (e.g. data sources) may provide varies and may include various information provided by a user of the system 100B, generated automatically by one or more of the components (e.g. data sources 120-134) of the system 100B or a combination thereof. In the example context of insurance claims processing, the workflow audit system 136 of system 100B includes the illustrated data sources 120-134 according to one embodiment. The applicant/claimant data device 120 may provide information from a user that initiated an application or claim. The witness/expert data device 122 may provide information from a user that may provide factual information, witness information, information as an expert such as a doctor or other technical subject matter. The evaluator/adjustor data device 124 may provide information from a user that provides an evaluation of an application or that is a claim adjustor. The investigator data device 126 may provide information from a user that is an investigator for an application or claim, for example to identify any missing information or anomalies in the application. The auditor device 128 may provide information from an auditor about a claim, either prior to the processing of the claim or after the processing of the claim (if the latter, this is label or ground truth data). The other information device 132 may provide information from a user of any other type of data used to evaluate or process the application or claim. The relationship device 134 may provide information about relationships of any person or entity associated with the application or claim. In some embodiments, the relationship device 134 may include one or more application interfaces to third party systems for social network information.

In some embodiments, the data sources 120-134 provide data (e.g. to the training server 102) automatically or responsive to being polled or queried. It should be noted that the data sources 124, 126, and 128 are shown within a dashed line 138 as they may be associated with a particular entity such as an insurance company, the Internal Revenue Service or college admissions office that undergoes and/or performs an audit. In some embodiments, the data sources 120-134 may process and derive the attributes for the type of data they provide. In other embodiments, the responsibility of processing and deriving the attributes is performed by the training server 102. Again, although several of data sources 120-134 are shown in FIG. 1B, this is merely an example system and different embodiments of the system 100B may include fewer, different, or more data sources 120-134 than those illustrated in FIG. 1B.

Referring again to FIG. 1A, it should be understood that the components (e.g. data sources) of the workflow auditing system 136 of system 100A may vary based on the complex processing workflow and may, therefore, allow input of different types or information to be provided or input to the training server 102.

Referring again to FIG. 1A, it should be understood that the present disclosure is intended to cover the many different embodiments of the system 100A that include the workflow auditing system 136, the network 106, the training server 102 having a machine learning unit 104, the prediction/scoring server 108 having the machine learning predictor 110, and the data repository 112. In a first example, the workflow auditing system 136, the training server 102, and the prediction/scoring server 108 may each be dedicated devices or machines coupled for communication with each other by the network 106. In a second example, one or more of the workflow auditing system 136, the training server 102, and the prediction/scoring server 108 may be combined as one or more devices configured for communication with each other via the network 106. More specifically, the training server 102 and the prediction/scoring server 108 may be the same server. In a third example, one or more of the workflow auditing system 136, the training server 102, and the prediction/scoring server 108 may be operable on a cluster of computing resources configured for communication with each other. In a fourth example, one or more of the workflow auditing system 136, the training server 102, and the prediction/scoring server 108 may be virtual machines operating on computing resources distributed over the Internet.

While the training server 102 and the prediction/scoring server 108 are shown as separate devices in FIGS. 1A and 1B, it should be understood that, in some embodiments, the training server 102 and the prediction/scoring server 108 may be integrated into the same device or machine. Particularly, where the training server 102 and the prediction/scoring server 108 are performing online learning, a unified configuration is preferred. Moreover, it should be understood that some or all of the elements of the system 100A may be distributed and operate on a cluster or in the cloud using the same or different processors or cores, or multiple cores allocated for use on a dynamic as-needed basis.

### Example Training Server 102

Referring now to FIG. 2, an example of a training server 102 is described in more detail according to one embodiment. The illustrated training server 102 comprises an input device 204, a communication unit 206, an output device 208, a memory 210, a processor 212 and the machine learning unit 104 coupled for communication with each other via a bus 220.

The input device 204 may include any device or mechanism for providing data and control signals to the training server 102 and may be coupled to the system directly or through intervening input/output controllers. For example, the input device 204 may include one or more of a keyboard, a mouse, a scanner, a joystick, a touchscreen, a webcam, a touchpad, a barcode reader, an eye gaze tracker, a sip-and-puff device, a voice-to-text interface, etc.

The communication unit 206 is coupled to signal lines 214 and the bus 220. The communication unit 206 links the processor 212 to the network 106 and other processing systems as represented by signal line 214. In some embodiments, the communication unit 206 provides other connections to the network 106 for distribution of files using standard network protocols such as transmission control protocol and the Internet protocol (TCP/IP), hypertext transfer protocol (HTTP), hypertext transfer protocol secure (HTTPS) and simple mail transfer protocol (SMTP) as should be understood to those skilled in the art. In some embodiments, the communication unit 206 is coupled to the network 106 or data repository 112 by a wireless connection and the communication unit 206 includes a transceiver for sending and receiving data. In such embodiments, the communication unit 206 includes a Wi-Fi transceiver for wireless communication with an access point. In some embodiments, the communication unit 206 includes a Bluetooth® transceiver for wireless communication with other devices. In some embodiments, the communication unit 206 includes a cellular communications transceiver for sending and receiving data over a cellular communications network such as via short messaging service (SMS), multimedia messaging service (MMS), hypertext transfer protocol (HTTP), direct data connection, wireless application protocol (WAP), email, etc. In still another embodiment, the communication unit 206 includes ports for wired connectivity such as but not limited to USB, SD, or CAT-5, etc.

The output device 208 may include a display device, which may include light emitting diodes (LEDs). The display device represents any device equipped to display electronic images and data as described herein. The display device may be, for example, a cathode ray tube (CRT), liquid crystal display (LCD), projector, or any other similarly equipped display device, screen, or monitor. In one embodiment, the display device is equipped with a touch screen in which a touch sensitive, transparent panel is aligned with the screen of the display device. The output device 208 indicates the status of the training server 102 such as: 1) whether it has power and is operational; 2) whether it has network connectivity; 3) whether it is processing transactions. Those skilled in the art should recognize that there may be a variety of additional status indicators beyond those listed above that may be part of the output device 208. The output device 208 may include speakers in some embodiments.

The memory 210 stores instructions and/or data that may be executed by processor 212. The instructions and/or data may comprise code for performing any and/or all of the techniques described herein. The memory 210 may be a dynamic random access memory (DRAM) device, a static random access memory (SRAM) device, flash memory or some other memory device known in the art. In one embodiment, the memory 210 also includes a non-volatile memory such as a hard disk drive or flash drive for storing information on a more permanent basis. The memory 210 is coupled by the bus 220 for communication with the other components of the training server 102.

The processor 212 comprises an arithmetic logic unit, a microprocessor, a general purpose controller or some other processor array to perform computations, provide electronic display signals to output device 208, and perform the processing of the present disclosure. The processor 212 is coupled to the bus 220 for communication with the other components of the training server 102. Processor 212 processes data signals and may comprise various computing architectures including a complex instruction set computer (CISC) architecture, a reduced instruction set computer (RISC) architecture, or an architecture implementing a combination of instruction sets. Although only a single processor 212 is shown in FIG. 2, multiple processors may be included. It should be understood that other processors, operating systems, sensors, displays and physical configurations are possible. The processor 212 may also include an operating system executable by the processor such as but not limited to WINDOWS®, Mac OS®, or UNIX® based operating systems.

The bus 220 represents a shared bus for communicating information and data throughout the training server 102. The bus 220 may represent one or more buses including an industry standard architecture (ISA) bus, a peripheral component interconnect (PCI) bus, a universal serial bus (USB), or some other bus known in the art to provide similar functionality. Components coupled to processor 212 by system bus 220 include the input device 204, the communication unit 206, the output device 208, the memory 210, and the machine learning unit 104.

In one embodiment, the machine learning unit 104 includes one or more machine learning models 250, a data collection module 252, a feature extraction module 254, a data fusion module 256, an action module 258, a model creation module 260, an active learning module 262 and a reinforcement learning module 264.

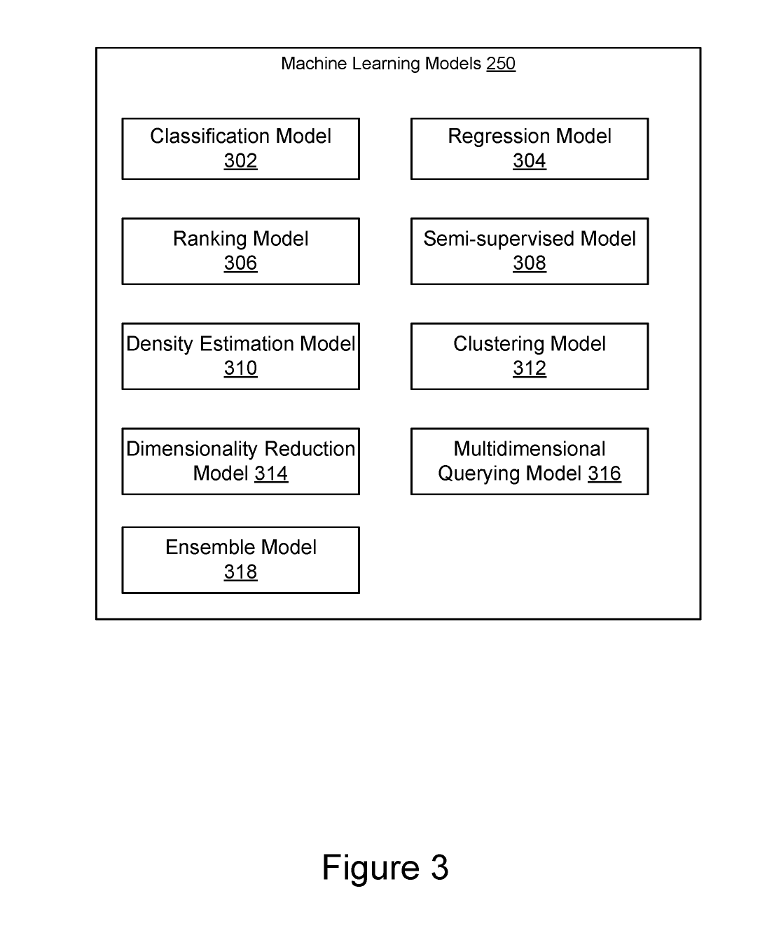

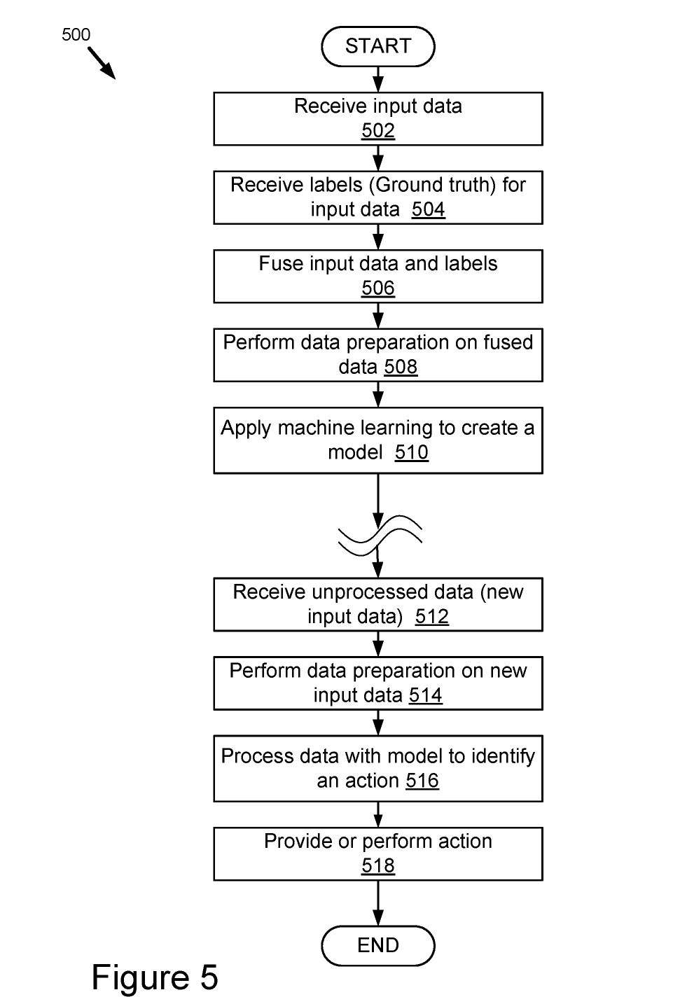

The one or more machine learning models 250 may include one or more example models that may be used by the model creation module 260 to create a model, which is provided to the prediction/scoring server 108. The machine learning models 250 may also include different models that may be trained and modified using the ground truth data received from the auditor device included in the workflow auditing system 136. Depending on the embodiment, the one or more machine learning models 250 may include supervised machine learning models only, unsupervised machine learning models only or both supervised and unsupervised machine learning models. The machine learning models 250 are accessible and provided to the model creation module 260 for creation of a model in accordance with the method of FIG. 5. Example models are shown and described in more detail below with reference to FIG. 3. The machine learning models 250 are coupled by the bus 220 to the other components of the machine learning unit 104.

Referring now to FIG. 3, an example of machine learning models 250 in accordance with one embodiment of the present disclosure are described. In the illustrated embodiment, the machine learning models 250 include a classification model 302, a regression model 304, a ranking model 306, a semi-supervised model 308, a density estimation model 310, a clustering model 312, a dimensionality reduction model 314, a multidimensional querying model 316 and an ensemble model 318, but other embodiments may include more, fewer or different models.

The classification model 302 is a model that may identify one or more classifications to which new input data belongs. The classification model 302 is created by using the fused data to train the model, and allowing the model based on labels from the audited data to determine parameters that are determinative of the label value. For example, the auditing of insurance claims and determining each claim as having either a label of legitimate or illegitimate may be used by the model creation module 260 to build a classification model 302 that determines the legitimacy of claims for exclusions such as fraud, jurisdiction, regulation or contract. In another example, the auditing of credit card purchases and disputes and determining each claim as having either a label of authorized or unauthorized may be used by the model creation module 260 to build a classification model 302 that determines the valid use of the credit cards during purchases for exclusions such as credit card fraud.

The regression model 304 is a model that may determine a value or value range. By training the regression model 304 on the fused data, the regression model 304 may estimate relationships among variables or parameters. For example, the regression model 304 may be used in insurance claims processing to determine a true amount that should have been paid, a range that should have been used, or some proxy or derivative thereof. In some embodiments, the model creation module 260 creates a regression model 304 that outputs the difference between what was determined to be paid during the audit and what should have been paid.

The ranking model 306 is a model that may determine a ranking or ordering based on true value or a probability of having a value for a parameter. The ranking model 306 may provide a ranked list of applications or claims from the greatest to the least difference from a true value. The order is typically induced by forcing an ordinal score or a binary judgment. The ranking model 306 may be trained, by the model creation module 260, with a partially ordered list including the input data and the label data. The ranking model 306 is advantageous because it may include more qualitative opinions and may be used to represent multiple objectives.

The semi-supervised model 308 is a model that uses training data that includes both labeled and unlabeled data. Typically, the semi-supervised model 308 uses a small amount of labeled data with a large amount of unlabeled data. For example, the semi-supervised model 308 is particularly applicable for use on insurance claims or tax filings, where only a small percentage of all claims or tax filings are audited and thus have label data. More specifically, the claims may be labeled with a legitimate value or an illegitimate value for the labeled data and a null value for the unlabeled data in one embodiment. Tax filings may be labeled with an over-paid, under-paid, or paid for the labeled data and null value for unlabeled data in one embodiment. The semi-supervised model 308 attempts to infer the correct labels for the unlabeled data.

The density estimation model 310 is a model that selects labeled rows of a particular value for that single label and uses only those rows to train the model. Then the density estimation model 310 may be used to score new data to determine if the new data should have the same value as the label. For example, in the insurance claim context, the density estimation model 310 may, in some embodiments, be trained, by the model creation module 260, only with rows of data that have the label legitimate in the audit column, or trained, by the model creation module 260, only with rows of data that have the label illegitimate in the audit column. Once the model has been trained by the model creation module 260, it may be used (e.g. at the prediction/scoring server 108) to score new data, and the rows may be determined to be labeled legitimate or illegitimate based on the underlying probability density function.

The clustering model 312 is a model that groups sets of objects in a manner that objects in the same group or cluster are more similar to each other than to other objects in other groups, which are occasionally referred to as clusters. For example, insurance claims or applications may be clustered based on parameters of the claims. The clustering model 312 created, by the model creation module 260, may assign a label to each cluster based on the claims in that cluster being labeled as legitimate or illegitimate. New claims may then be scored (e.g. at the prediction/scoring server 108) by assigning the claim to a cluster and determining the label assigned to that cluster.

It should be recognized that the use of ground truth from audited data with an unsupervised machine learning model is not incompatible and may allow for interesting use cases. For example, let us consider clustering, which is commonly considered an unsupervised machine learning model. When the ground truth is used to identify a “correct” clustering, this is classification (i.e. supervised). When the ground truth data is used to indicate one or more of certain members (e.g. claims) that should be in the same cluster, how many clusters should exist (e.g. overpaid, underpaid and correctly paid), where the center of a cluster should be, etc., this is semi-supervised. However, unsupervised clustering may be used, in some embodiments, to identify one or more clusters of applicants that are consistently flagged (according to ground truth) and identify the one or more properties associated with each of the one or more clusters. The ground truth data may also be used to validate an unsupervised model created by the model creation module 260.

The dimensionality reduction model 314 is a model that reduces the number of variables under consideration using one or more of feature selection and feature extraction. Examples of feature selection may include filtering (e.g. using information gain), wrapping (e.g. search guided by accuracy) embedding (variables are added or removed as the model creation module 260 creates the model based on prediction errors), etc. For example, in the credit card fraud context, the dimensionality reduction model 314 may be used by the model creation module 260 to generate model that identifies a transaction as fraudulent or non-fraudulent based on a subset of the received input data.

The multidimensional querying model 316 is a model that finds the closest or most similar points. An example of a multidimensional querying model 316 is nearest neighbors; however, it should be recognized that other multidimensional querying models exist, and their use is contemplated and within the scope of this disclosure. For example, in the credit card fraud context, a transaction may be identified as fraudulent or non-fraudulent based on the label(s) of its nearest neighbors.

The ensemble model 318 is a model that uses multiple constituent machine learning algorithms. For example, in one embodiment, the ensemble model 318 may be boosting and, in the context of insurance claims, the ensemble model 318 is used by the model creation module 260 to incrementally build a model by training each new model instance to emphasize training instances (e.g. claims) miss-classified by the previous instance(s). It should be recognized that boosting is merely one example of an ensemble model and other ensemble models exist and their use is contemplated and within the scope of this disclosure.

The data collection module 252 may include software and routines for collecting data from the workflow auditing system 136. For example, the data collection module 252 receives or retrieves data from the plurality of data sources 120-134 included in the workflow auditing system 136 as shown in the example of FIG. 1B and formats and stores the data in the data repository 112. In some embodiments, the data collection module 252 may be a set of instructions executable by the processor 212 to provide the functionality described below for collecting and storing data from the workflow auditing system 136. In some other embodiments, the data collection module 252 may be stored in the memory 210 of the training server 102 and may be accessible and executable by the processor 212. The data collection module 252 may be adapted for cooperation and communication with the processor 212 and other components of the training server 102 via the bus 220.

The feature extraction module 254 may include software and routines for performing feature extraction on the data collected and stored by the data collection module 252 in the data repository 112. The feature extraction module 254 may perform one or more feature extraction techniques. In some embodiments, the feature extraction module 254 may be a set of instructions executable by the processor 212 to provide the functionality for performing feature extraction on the data collected by the data collection module 252. In some other embodiments, the feature extraction module 254 may be stored in the memory 210 of the training server 102 and may be accessible and executable by the processor 212. The feature extraction module 254 may be adapted for cooperation and communication with the processor 212 and other components of the training server 102 via the bus 220.

The data fusion module 256 may include software and routines for performing data fusion between the ground truth data and the other input data collected by the data collection module 252. The data fusion module 256 may perform a join or other combination of the features extracted from the ground truth data and the input data by the feature extraction module 254. In one embodiment, the data fusion module 256 identifies a common identifier, i.e. an identifier in both the ground truth data and the input data, and uses the common identifier to fuse ground truth data and input data. For example, in one embodiment, the data fusion module 256 automatically (i.e. without user intervention) an identifier (e.g. an insurance claim number) common to ground truth data (e.g. audit data) and input data and fuses the input data and ground truth data using the common identifier. For purposes of this application, the terms “label” and “ground truth data” are used interchangeably to mean the same thing, namely, a ground truth value determined from the performance of an audit, for example, of a process. In some embodiments, the data fusion module 256 performs data preprocessing, occasionally referred to as data preparation, on the fused data or inputs thereof (e.g. ground truth data or input data). For example, data preprocessing may include data cleaning, removal of outliers, identifying and treating missing values, and transformation of values, etc. In a particular example case of text data, this may include bag-of-words transformation, stemming, stop word removal, topic modeling, etc. In some embodiments, the data fusion module 256 may be a set of instructions executable by the processor 212 to provide the functionality for performing data fusion. In some other embodiments, the data fusion module 256 may be stored in the memory 210 of the training server 102 and may be accessible and executable by the processor 212. The data fusion module 256 may be adapted for cooperation and communication with the processor 212 and other components of the training server 102 via the bus 220.

The action module 258 may include software and routines for determining and prescribing an action that should be performed based on the prediction of the model and any applied constraints. In some embodiments, the action module 258 may be a set of instructions executable by the processor 212 to provide the functionality for prescribing an action that should be performed based on the prediction of the model. In some other embodiments, the action module 258 may be stored in the memory 210 of the training server 102 and may be accessible and executable by the processor 212. The action module 258 may be adapted for cooperation and communication with the processor 212 and other components of the training server 102 via the bus 220.

The model creation module 260 may include software and routines for creating a model (to send to the prediction/scoring server 108) by applying machine learning to the fused data received from the data fusion module 256. In some embodiments, the model creation module 260 may be a set of instructions executable by the processor 212 to provide the functionality for applying machine learning. In some other embodiments, the model creation module 260 may be stored in the memory 210 of the training server 102 and may be accessible and executable by the processor 212. The model creation module 260 may be adapted for cooperation and communication with the processor 212 and other components of the training server 102 via the bus 220.

As should be recognized by the discussion above with regard to machine learning models 302-312, the type of model chosen and used by the model creation module 260 depends on the specific task and the data (including fused data) available. For example, if the goal is to determine the amount of leakage on any particular claim in an insurance claims processing workflow, then a regression model 304 is trained by the model creation module 260 from the previously audited claims and the amounts of leakage found in these claims upon review. Leakage refers to a difference between what was paid and what should have been paid (often when what was paid exceeds what should have been paid). Once the model has been created, it may be used to process new or additional data (e.g. unprocessed and/or new insurance claims). In another example, if the goal is to prioritize which among a group of tax documents/returns should be selected for a review in a tax return processing workflow, then a ranking model 306 may be trained by the model creation module 260 on the set of previously available tax documents with the previous auditors' choices of which of these documents to review (i.e. fused data), and the results of the reviews used as labels. The model creation module 260 selects one of the machine learning models 250 for use by the predictive/scoring server 208. It should be noted that the models generated by the model creation module 260 are notably distinct as they incorporate information from the ground truth data. Within each model, the system 100A may incorporate competing labels. For example, labels that have been provided by multiple experts or auditors (which may or may not be in agreement).

The active learning module 262 may include software and routines for performing active learning. For example, active learning may include identifying particular data or rows that have particular attributes that may be used to improve the model generated by the model creation module 260, determine which features are more important to model accuracy, identify missing information corresponding to those attributes and try to secure additional information to improve the performance of the model generated by the model creation module 260. For example, the active learning module 262 may cooperate with the data sources 120-134 in the workflow auditing system 136 to secure the additional information (e.g. from one or more users) under the constraints of what is permissible under the applicable laws. In some embodiments, the active learning module 262 may be a set of instructions executable by the processor 212 to provide the functionality for performing active learning. In some other embodiments, the active learning module 262 may be stored in the memory 210 of the training server 102 and may be accessible and executable by the processor 212. The active learning module 262 may be adapted for cooperation and communication with the processor 212 and other components of the training server 102 via the bus 220.

The reinforcement learning module 264 may include software and routines for performing reinforcement learning where the model generated accounts for the future consequences of taking a particular action and try to identify an optimal action. The reinforcement learning module 264 may identify particular changes based on the predicted action or look for tipping points at which the recommended action has different or greater consequences. In some embodiments, the reinforcement learning module 264 may be a set of instructions executable by the processor 212 to provide reinforcement learning. In some other embodiments, the reinforcement learning module 264 may be stored in the memory 210 of the training server 102 and may be accessible and executable by the processor 212. The reinforcement learning module 264 may be adapted for cooperation and communication with the processor 212 and other components of the training server 102 via the bus 220.

### Example Prediction/Scoring Server 108

Referring now to FIG. 4, an example of a prediction/scoring server 108 is described in more detail according to one embodiment. The prediction/scoring server 108 receives a model from the training server 102, uses the model to process new data and provides or takes actions prescribed by the model. The prediction/scoring server 108 comprises an input device 416, a communication unit 418, an output device 420, a memory 422, a processor 424 and the machine learning predictor 110 coupled for communication with each other via a bus 426.

Those skilled in the art should recognize that some of the components of the prediction/scoring server 108 have the same or similar functionality as some of the components of the training server 102 so descriptions of these components is not be repeated here. For example, the input device 416, the communication unit 418, the output device 420, the memory 422, the processor 424, and the bus 426 are similar to those described above.

In one embodiment, the machine learning predictor 110 includes a machine learning model 402, a data collection module 404, a feature extraction module 406, an action module 408, a model updating module 410, an active learning module 412 and a reinforcement learning module 414. The machine learning predictor 110 has a number of applications. First, the machine learning predictor 110 may be used to analyze new data, occasionally referred to as unprocessed data, for the purpose of identifying a mistake or error before it occurs and preventing it. For example, the machine learning predictor 110 may be applied to new data such as a recent insurance claim being processed in an insurance claims processing workflow to predict whether that claim is headed toward leakage. If so, the leakage may then possibly be prevented via interventional action performed by the action module 408. Second, the machine learning predictor 110 may be used to go over new data such as past, unanalyzed data retrieved from the workflow auditing system 136 to identify issues. For example, again in the insurance claim context, the model may be used to go back over past unaudited insurance claims to detect possible leakages. This may be used this to obtain deeper insights into the mechanisms responsible for leakage, or even to re-open claims in some cases.

The machine learning model 402 is the mathematical model generated by the machine learning unit 104 that may be used to make predictions and decisions on new data. In some embodiments, the machine learning model 402 may include ensemble methods, model selection, parameter selection and cross validation. It should be understood that the machine learning model 402 is particularly advantageous because the model may operate on partial and incomplete data sets. The machine learning model 402 cooperates with the feature extraction module 406 and the action module 408 to predict an appropriate action based on the features provided by the feature extraction module 406. The machine learning model 402 may be adapted for cooperation and communication with the processor 424 and other components of the prediction/scoring server 108 via the bus 426.

The data collection module 404 may include software and routines for collecting a new set of data from the workflow auditing system 136 for analysis. The data collection module 404 is similar to the data collection module 252 in FIG. 2 but for new data. The data collection module 404 collects data from the workflow auditing system 136 and stores it in the data repository 112 for use by the feature extraction module 406. In some embodiments, the data collection module 404 also performs data preprocessing, occasionally referred to as data preparation, before storing the data in the data repository 112. For example, data preprocessing may include data cleaning, removal of outliers, identifying and treating missing values, and transformation of values, etc. In a particular example case of text data, this may include bag-of-words transformation, stemming, stop word removal, topic modeling, etc. In some embodiments, the data collection module 404 may be a set of instructions executable by the processor 424 to provide the functionality described below for collecting and storing data from the workflow auditing system 136. In some other embodiments, the data collection module 404 may be stored in the memory 422 of the prediction/scoring server 108 and may be accessible and executable by the processor 424. The data collection module 404 may be adapted for cooperation and communication with the processor 424 and other components of the prediction/scoring server 108 via the bus 426.

The feature extraction module 406 may include software and routines for performing feature extraction on the new set of data collected by the data collection module 404. The feature extraction module 406 is similar to the feature extraction module 254 in FIG. 2 but acting on the new set of data collected by the data collection module 404. In some embodiments, the feature extraction module 406 may be a set of instructions executable by the processor 424 to provide the functionality described herein for performing feature extraction. In some other embodiments, the feature extraction module 406 may be stored in the memory 422 of the prediction/scoring server 108 and may be accessible and executable by the processor 424. The feature extraction module 406 may be adapted for cooperation and communication with the processor 424 and other components of the prediction/scoring server 108 via the bus 426.

The action module 408 may include software and routines for performing the action specified by the prediction of the machine learning model 402. In some embodiments, the action module 408 may be a set of instructions executable by the processor 424 to provide the functionality described herein for performing the action specified by the prediction of the machine learning model 402. In some other embodiments, the action module 408 may be stored in the memory 422 of the prediction/scoring server 108 and may be accessible and executable by the processor 424. The action module 408 may be adapted for cooperation and communication with the processor 424 and other components of the prediction/scoring server 108 via the bus 426.

The model updating module 410 may include software and routines for updating the machine learning model 402 based on the new information retrieved and processed by the machine learning predictor 110. In some embodiments, the training server 102 and the prediction/scoring server 108 are the same server for optimum operation of the model updating module 410. Moreover in some embodiments, the model updating module 410 is operating continuously so online learning is performed and the machine learning model 402 is continually being updated. In some other embodiments, the model updating module 410 may be stored in the memory 422 of the prediction/scoring server 108 and may be accessible and executable by the processor 424. The model updating module 410 may be adapted for cooperation and communication with the processor 424 and other components of the prediction/scoring server 108 via the bus 426.

The active learning module 412 may include software and routines for performing active learning. For example, active learning may include identifying particular data or rows that have particular attributes that may be used to improve the machine learning model 402, determine which features are more important to model accuracy, identify missing information corresponding to those attributes and try to secure additional information to improve the performance of the machine learning model 402. For example, the active learning module 412 may cooperate with the data sources 120-134 in the workflow auditing system 136 to secure the additional information (e.g. from one or more users) under the constraints of what is permissible under the applicable laws. In some embodiments, the active learning module 412 may be a set of instructions executable by the processor 424 to provide the functionality for performing active learning. In some other embodiments, the active learning module 412 may be stored in the memory 422 of the prediction/scoring server 108 and may be accessible and executable by the processor 424. The active learning module 412 may be adapted for cooperation and communication with the processor 424 and other components of the prediction/scoring server 108 via the bus 426.

The reinforcement learning module 414 may include software and routines for performing reinforcement learning where the machine learning model 402 accounts for the future consequences of taking a particular action and tries to identify an optimal action. The reinforcement learning module 414 may identify particular changes based on the predicted action or look for tipping points at which the recommended action has different or greater consequences. In some embodiments, the reinforcement learning module 414 may be a set of instructions executable by the processor 424 to provide reinforcement learning. In some other embodiments, the reinforcement learning module 414 may be stored in the memory 422 of the prediction/scoring server 108 and may be accessible and executable by the processor 424. The reinforcement learning module 414 may be adapted for cooperation and communication with the processor 424 and other components of the prediction/scoring server 108 via the bus 426.

### Example Methods

FIG. 5 is a flowchart of an example method 500 for generating a model using audited data and using the model to process new data in accordance with one embodiment of the present disclosure. The method 500 begins at block 502. At block 502 the data collection module 252 of the machine learning unit 104 receives input data. In one embodiment, the data collection module 252 may collect and store input data received from a workflow auditing system 136. For example, the input data may be from different sources 120-134 as shown by FIG. 1B. The input data may be of various different types as shown in FIGS. 6A. The input data may include different inputs according to a particular use case or task as shown by FIGS. 6B and 6C. More specifically, the data collection module 252 of the machine learning unit 104 of the training server 102 may collect and store input data received from the workflow auditing system 136 in the data repository 112. In some embodiments, the machine learning unit 104, or one or more components thereof, also manages and consolidates the input data in the data repository 112.

At block 504, data collection module 252 receives labels or ground truth data. The label may be provided as manual input of an auditor (human being) evaluating a process or result thereof. Alternatively, the label may be provided or derived from an automated auditing procedure (also an auditor) that is applied to a process or result thereof. Examples of labels are described in more detail below with reference to FIG. 7. In some embodiments, the data collection module 252 collects and stores labels or ground truth data (“audit data”) from the auditor device 228 as shown in the example of FIG. 1B and stores it in the data repository 112. In some embodiments, the training server 102 also manages and aggregates the audit data in the data repository 112 along with the input data. At block 506, the data fusion module 256 fuses the input data (from block 502) and the ground truth data (from block 504) to create fused data. The method 500 may also fuse data with disparate modalities depending on the embodiment. For example, the data fusion module 256 may perform a join operation (or other combining operation) on the input data and the ground truth data using a common identifier or index to create fused data. Different forms of data may be collected, for example, in the context of insurance claims processing, data including but not limited to, case details in the form of structured (tabular) data, the contents of forms in the form of free text notes, and the sequence and duration of phases or events during the process. These very different forms of data are fused together to obtain usefully accurate results. At block 508, the data fusion module 256 performs data preparation on the fused data. At block 510, the model creation module 260 uses the fused and prepared data to create a model. For example, the model creation module 260 may apply machine learning, at block 510, to create a model from the fused data. Example models that may be created are described above with reference to FIG. 3. In yet a more particular example, in the context of insurance claims processing, a model is learned, in one embodiment, which estimates the likelihood of leakage for a given claim and/or the expected leakage cost.

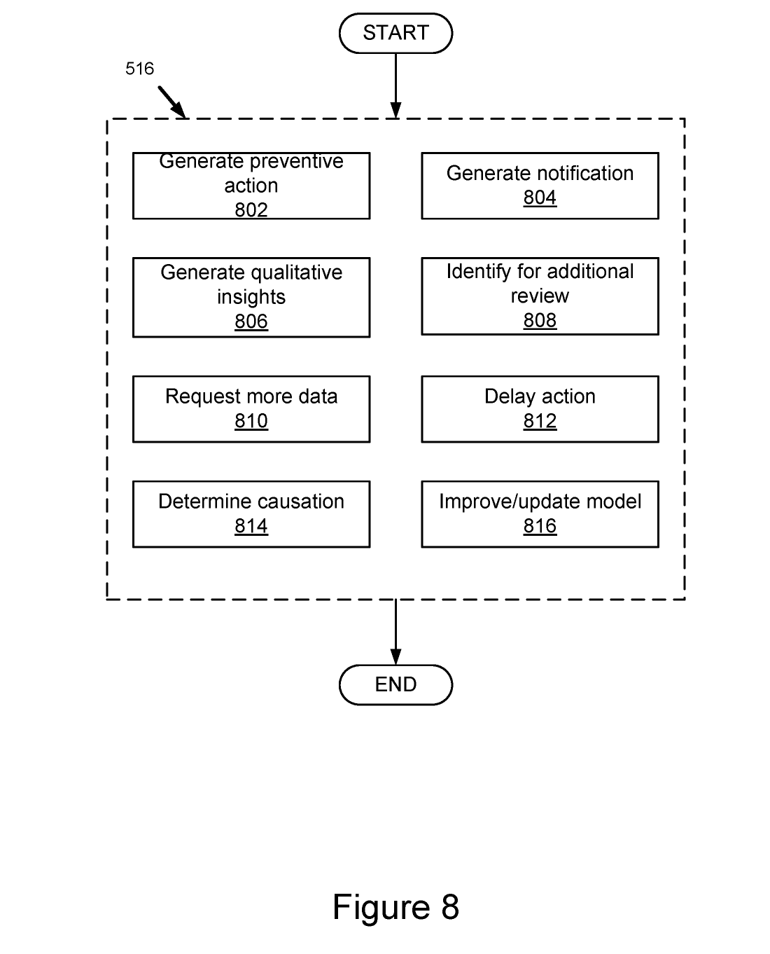

As illustrated in FIG. 5, there may be a significant time separation between model creation in steps 502-510 and use of the model in steps 512-518. In some embodiments, the model, once created, is sent to and used by the prediction/scoring server 108. The method 500 continues at block 512. At block 512, the data collection module 404 of the machine learning predictor 110 of the prediction/scoring server 108 receives unprocessed data, occasionally referred to as “new data.” At block 514, the data collection module 404 processes the unprocessed data by performing data preparation on it. This is similar to the data preparation described above with reference to step 508 but on the unprocessed data. For example, in the example context of insurance claims, step 508 may be performed on fused data that relates to past insurance claims and step 514 may be performed on new insurance claims, a different set of past insurance claims or a combination thereof. At block 516, the machine learning module 402 cooperates with the feature extraction module 406 and the action module 408 to processes the pre-processed data from block 514 with the model created at block 510 to identify an action for presentation or performance by the action module 408. Example actions that may be presented or performed are described in more detail below with reference to FIG. 8. At block 516, the action module 408 provides or performs the action identified at block 516. For example, the action may be provided as input to another system or for manual intervention or performance. In another example, the action is automatically performed to avoid an undesired result.

Referring now to FIGS. 6A-6C and 7, it should be understood that while FIGS. 6A-6C and 7 includes a number of steps illustrated in a predefined order, the methods described by those figures may not perform all of the illustrated steps or perform the steps in the illustrated order. One or more of the methods described by one of FIGS. 6A-6C and 7 may include any combination of the illustrated steps (including fewer or additional steps) different than that shown in the figure, and the method may perform such combinations of steps in other orders.

Referring now to FIGS. 6A-6C, it should be recognized that the systems and methods described herein may be apply to a wide variety of complex process workflows and that, depending on the complex process workflow, the workflow auditing system 136 and the embodiment, the input data received at block 502 of FIG. 5 may vary. FIGS. 6A-6C are example methods of receiving input data and describe examples illustrating the potential diversity of the input data that may be received. For example, FIG. 6A illustrates, among other things, that input data may have various formats, information type/content, etc., and FIGS. 6B and 6C illustrate, among other things, that input data may vary based on and correspond to actors (e.g. auditors, claimants, customers, etc.), steps or actions of the complex process workflow. It should be recognized that FIGS. 6A-6C are merely examples provided for clarity and convenience and other input data exists and is within the scope of this disclosure.

Referring now to FIG. 6A, an example method 502a for receiving input data in accordance with the one embodiment present disclosure is described. The method 502a begins at block 602. At block 602, the data collection module 252 retrieves text. The text is then processed and stored in the data repository 112. In an alternate embodiment the text may be sent directly to the training server 102. At block 604, the data collection module 252 retrieves audio data. At block 606, the data collection module 252 retrieves video data. At block 608, the data collection module 252 retrieves time series data, e.g., time stamps of correspondence or communications. At block 610, the data collection module 252 retrieves structured or tabular data. At block 612, the data collection module 252 retrieves graph or relationship data such as from a social network service. At block 614, the data collection module 252 retrieves form data. At block 616, the data collection module 252 retrieves biometric data. At block 618, the data collection module 252 retrieves image data. At block 620, the data collection module 252 retrieves any other type of data. As with block 602, the other blocks of the method 502a may process and store the received data in the data repository 112 or provide it directly to the training server 102 or a component thereof.

Referring now to FIG. 6B, another example of a method 502b for receiving input data in accordance with one embodiment of the present disclosure is described. FIG. 6B illustrates an example where input data is data used to process insurance claims, which may be received from one or more of the data sources 120-134 illustrated in FIG. 1B. The method 502b begins at block 622. At block 622, the data collection module 252 retrieves claimant data. Claimant data may include a statement from the claimant, in the form of a standard form, narrative, recorded and/or transcribed statement. The claimant data is then processed and stored in the data repository 112. In an alternate embodiment the claimant data may be sent directly to the training server 102. At block 624, the data collection module 252 retrieves witness data. Witness data may include witness statements, emails, testimony in video or audio, etc. At block 626, the data collection module 252 retrieves expert data. Expert data may include any testimony, reports, findings, documents or other information from any expert in a particular field. At block 628, the data collection module 252 retrieves medical data. Medical data may include any testimony, reports, test results, documents, etc. from medical personnel that provide treatment to the claim or other injured party, procedures/treatments prescribed for the claimants and the costs of these procedures. At block 630, the data collection module 252 retrieves profile or history data. The profile data may be the medical/personal/accident history of any party involved in the claim, preexisting conditions, length of time insured/length of tenure with the employer, personal bio on third party services, criminal history, credit history, etc. At block 632, the data collection module 252 retrieves graph or relationship data. Relationship data may include the identities/specializations/histories of the attorneys hired by the claimant, the identities/specializations/histories of doctors hired by the claimant, the relationship of claimant to other parties (doctors, lawyers, investigators, adjustors, experts, injured, etc.) related to the claim. At block 634, the data collection module 252 retrieves event data. Event data may include events leading up to the claim. At block 636, the data collection module 252 retrieves investigator data. Investigator data may include potential in looking for the cause of the claim or possible premeditation and/or factual dispute that may lead to a claim being placed on delay for further investigation. At block 638, the data collection module 252 retrieves correspondence with timestamps. Correspondence with timestamps may include timestamp information as well as information about the delays between claims, reports, and the administered benefits. As with block 622, the other blocks of the method 502b may process and store the received data in the data repository 112 or provide it directly to the training server 102 or a component thereof.

Referring now to FIG. 6C, a flowchart of a second example of a method 502c for receiving input data in accordance with another embodiment of the present disclosure is described. FIG. 6C illustrates examples of input data that may be received by the data collection module 252 to process credit card fraud. The method 502c begins at block 640. At block 640, the data collection module 252 retrieves customer data. The customer data may include name, income, credit card type, bank account, checking account, savings account, etc. The customer data is then processed and stored in the data repository 112. In an alternate embodiment, the customer data may be sent directly to the training server 102. At block 642, the data collection module 252 retrieves transaction data. The transaction data includes transaction ID, transaction type, merchant category, amount, currency type, local currency amount, transaction location, etc. At block 644, the data collection module 252 retrieves spending profile or history data. The spending profile data may be spending history of the customer, minimum transaction amount, maximum transaction amount, transaction floor limit, customer preferences, etc. At block 646, the data collection module 252 retrieves relationship graph or relationship data. The relationship data may include the identities of the customer's spouse, children, parents, the relationship of the customer with the entity involved in the transaction, etc. At block 648, the data collection module 252 retrieves event data. The event data may include the transaction event, whether online or point of sale (POS), POS type, automated teller machine (ATM), ATM ID, etc. At block 650, the data collection module 252 retrieves specialist data. The specialist data may include report, documents, etc. from the credit card security specialist that specialist used to identify the transaction as fraud or to clear the transaction as legitimate. As with block 640, the other blocks of the method 102c may process and store the received data in the data repository 112 or provide it directly to the training server 102 or a component thereof.

Referring now to FIG. 7, an example of a method 504 for receiving labels or ground truth data in accordance with one embodiment of the present disclosure is described. It should be understood that the labels may be provided by one or more labelers/auditors from either a manual or automated process. Moreover, in some embodiments, any labels provided by labelers/auditors may be potentially conflicting (e.g., two auditors potentially disagreeing over the correct course of action). The method 504 begins at block 702. At block 702, the data collection module 252 retrieves validity labels. Validity labels have a binary value and provide a verification that the chosen action/sequence of actions taken was correct/incorrect. Example validity labels include: true/false, correct/incorrect, legitimate/illegitimate, etc. At block 704, the data collection module 252 retrieves qualification labels. Qualification labels define set categories. For example, fraud, not covered by jurisdiction or regulation, contractual procedure not followed, limited information available at the time claim was acted upon, mistakes by experts (e.g., doctors not attributing the injury to chronic conditions), etc. At block 706, the data collection module 252 retrieves quantification labels. Quantification labels provide a number of real-values or range of real-values. For example, the suggested claim value or a suggested range of values for the claim. At block 708, the data collection module 252 retrieves correction labels. Correction labels provide sequences of suggested correct steps that should have been taken or remedial steps (e.g., reopening the claim) to correct the past incorrect steps. At block 710, the data collection module 252 retrieves preference labels. Preference labels are partially ordered lists of one action over others. For example, preference labels may indicate a preference for having a claim or a set of claims re-examined over other claims or other sets of claims. At block 712, the data collection module 252 retrieves 712 likelihood labels Likelihood labels are probabilities of a particular action happening in the future. For example, probability (according to the auditor/labeler) of a claim being re-examined and/or re-opened in the future, whether by the provider or the recipient. At block 714, the data collection module 252 retrieves similarity labels. Similarity labels are groups or partitions of the data. For example, claims having similar properties as pointed out by the auditor/labeler, and thus requiring similar actions. As with block 702, the other blocks of the data collection module 252 may process and store the received data in the data repository 112 or provide it directly to the training server 102.

FIG. 8 is a flowchart of an example of a method 516 for identifying an action in response to processing new data with the model created from audited data in accordance with one embodiment the present disclosure. The model may identify a particular action for processing an ongoing task, for example, applications or claims having parameter values that match the model. Specific actions may depend on the type of the model and the question being addressed. For example, a likelihood model may be used to predict the probability of payout in an insurance claim processing task, and depending on the prediction, the adjuster may decide how much of the resources to devote to the claim. Similarly, a ranking model, for example, may predict a relative score corresponding to how likely a tax return is to be improper/fraudulent in a tax return processing task, and these scores may be used to determine which returns should be audited. Another example is that classification models are used to determine where different actions might be taken based on the class probability assigned by the model. For example, if the probability approaches 50%, the model may seek to collect further data (e.g. data as described in FIG. 6A). The action identified at block 516, which may be performed by the action module 408, may include one or more of taking preventive action 802, generating a notification 804, generating qualitative insights 806 of which features or parameters are predictive of a particular result such as fraud, malfeasance or error in complex processing workflow or tasks, identifying a task, for example, a claim or application, for additional review 808, requesting more data 810 from the workflow auditing system 136, delaying action 812, determining causation 814 or improving or updating the model 816. Since one or more actions may be identified and those one or more actions may vary based on a number of factors, the actions 802-816 are illustrated within the dashed box 516.

It should be understood that the model or the action module 408 may also specify, at block 516, a role assigned to each action. For example, in the insurance claim context, one or more of the actions may be taken or caused to be taken by the adjuster, the investigator, the auditor or other person associated with the insuring company. In one embodiment, the model is applied to the real time processing of data, for example, insurance claims as they are made to take the appropriate action as determined by the model. In another embodiment, the claims that have already been processed are scored with the model to determine the appropriate action. That appropriate action is then compared to the action actually taken on a claim and the discrepancies are examined.

The foregoing description of the embodiments of the present disclosure has been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As should be understood by those familiar with the art, the present disclosure may be embodied in other specific forms without departing from the spirit or essential characteristics thereof. Likewise, the particular naming and division of the modules, routines, features, attributes, methodologies and other aspects are not mandatory or significant, and the mechanisms that implement the present disclosure or its features may have different names, divisions and/or formats. Furthermore, as should be apparent to one of ordinary skill in the relevant art, the modules, routines, features, attributes, methodologies and other aspects of the present disclosure may be implemented as software, hardware, firmware or any combination of the three. Also, wherever a component, an example of which is a module, of the present disclosure is implemented as software, the component may be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present disclosure is in no way limited to implementation in any specific programming language, or for any specific operating system or environment. Accordingly, the disclosure of the present disclosure is intended to be illustrative, but not limiting, of the scope of the present disclosure, which is set forth in the following claims.

What is claimed is:

1. A computer-implemented method comprising:
receiving input data;
receiving ground truth data from an audit evaluating the input data;
fusing the input data and the ground truth data to create fused data; and
applying machine learning to create a model from the fused data.

2. The computer-implemented method of claim 1, further comprising:
receiving unprocessed data;
processing the unprocessed data with the model created from the fused data to identify an action; and
one or more of providing the action and performing the action.

3. The computer-implemented method of claim 1, wherein fusing the input data and the ground truth data to create the fused data comprises:
identifying a common identifier;
fusing the input data and the ground truth data using the common identifier; and
performing data preparation on the fused data.

4. The computer-implemented method of claim 1, wherein the input data is relating to a complex processing workflow.

5. The computer-implemented method of claim 1, wherein the ground truth data is received from an auditor.

6. The computer-implemented method of claim 1, wherein the model includes one or more of a classification model, a regression model, a ranking model, a semi-supervised model, a density estimation model, a clustering model, a dimensionality reduction model, a multidimensional querying model and an ensemble model.

7. The computer-implemented method of claim 2, wherein the action includes one or more of a preventive action, generating a notification, generating qualitative insights, identifying a process from the input data for additional review, requesting more data, delaying the action, determining causation, and updating the model.

8. The computer-implemented method of claim 1, wherein the ground truth data includes one or more of validity data, qualification data, quantification data, correction data, preference data, likelihood data or similarity data.

9. A system comprising:
one or more processors; and
a memory including instructions that, when executed by the one or more processors, cause the system to:
receive input data;
receive ground truth data from an audit evaluating the input data;
fuse the input data and the ground truth data to create fused data; and
apply machine learning to create a model from the fused data.

10. The system of claim 9, wherein the instructions, when executed by the one or more processors, cause the system to:
receive unprocessed data;
process the unprocessed data with the model created from the fused data to identify an action; and
one or more of provide the action and perform the action.

11. The system of claim 9, wherein to fuse the input data and the ground truth data to create the fused data, the instructions when executed by the one or more processors, cause the system to:
identify a common identifier;
fuse the input data and the ground truth data using the common identifier; and
perform data preparation on the fused data.

12. The system of claim 9, wherein the input data is relating to a complex processing workflow.

13. The system of claim 9, wherein the ground truth data is received from an auditor.

14. The system of claim 9, wherein the model includes one or more of a classification model, a regression model, a ranking model, a semi-supervised model, a density estimation model, a clustering model, a dimensionality reduction model, a multidimensional querying model and an ensemble model.

15. The system of claim 10, wherein the action includes one or more of a preventive action, generating a notification, generating qualitative insights, identifying a process from the input data for additional review, requesting more data, delaying the action, determining causation, and updating the model.

16. The system of claim 9, wherein the ground truth data includes one or more of validity data, qualification data, quantification data, correction data, preference data, likelihood data or similarity data.

17. A computer-program product comprising a non-transitory computer usable medium including a computer readable program, wherein the computer readable program, when executed on a computer, causes the computer to perform operations comprising:
receiving input data;
receiving ground truth data from an audit evaluating the input data;
fusing the input data and the ground truth data to create fused data; and
applying machine learning to create a model from the fused data.

18. The computer program product of claim 17, wherein the operations further comprise:
receiving unprocessed data;
processing the unprocessed data with the model created from the fused data to identify an action; and
one or more of providing the action and performing the action.

19. The computer program product of claim 17, wherein fusing the input data and the ground truth data to create the fused data includes:
identifying a common identifier; and
fusing the input data and the ground truth data using the common identifier;
performing data preparation on the fused data.

20. The computer program product of claim 17, wherein the input data is relating to a complex processing workflow.
